(19) United States
(12) Patent Application Publication
(10) Pub. No.: US 2025/0301538 A1
(43) Pub. Date: Sep. 25, 2025

(54) COOKING ELEMENT WITH A SELECTABLY CONCENTRATABLE POWER ARRANGEMENT AND A METHOD OF SELECTABLY CONCENTRATING POWER OF A COOKING ELEMENT

(71) Applicant: WINNERS PRODUCTS ENGINEERING CANADA LTD., Toronto (CA)

(72) Inventor: James HOU, Toronto (CA)

(21) Appl. No.: 19/231,726

(22) Filed: Jun. 9, 2025

Related U.S. Application Data
(63) Continuation of application No. PCT/CA2023/051627, filed on Dec. 7, 2023.
(60) Provisional application No. 63/386,554, filed on Dec. 8, 2022.

(51) Int. Cl. H05B 1/02

(52) U.S. Cl. CPC H05B 1/0261

(57) ABSTRACT

Provided is a cooking element with a selectably concentratable power arrangement and a method of selectably concentrating power of a cooking element. The cooking element including: two or more heating sub-elements, each of the heating sub-elements having respective peak outputs; and a control unit, the control unit selectively routing power to a first grouping of the heating sub-elements in a regular operating mode and routing power to a second grouping in a concentrated operating mode, the first grouping including a greater number of heating sub-elements than the second grouping, the peak power routed to each of the heating sub-elements in the second grouping in the concentrated operating mode is greater than the peak power routed to each of the heating sub-elements the first grouping in the regular operating mode.

### TECHNICAL FIELD

The following generally relates to the field of cooking and heating appliances, and more particularly to a cooking element with concentrated power arrangement and a method of selectively concentrating power in the cooking element.

### BACKGROUND

Cooking or burner elements are generally provided with a cooking appliance, such as a stove, to heat cooking vessels, such as pots and pans, in order to transfer such heat to food items located within such vessels. In some cases, the food items require lower heat for slower cooking, while in other cases, the food may require high heat for more direct cooking, such as for searing. However, limitations in cooking element design and power requirements effectively limit the high heat output when a user may also like to use a larger lower heat application.

### SUMMARY

In an aspect, there is provided a cooking element with a selectably concentratable power arrangement, comprising: two or more heating sub-elements, each of the heating sub-elements having respective peak outputs; and a control unit, the control unit selectively routing power to a first grouping of the heating sub-elements in a regular operating mode and routing power to a second grouping in a concentrated operating mode, the first grouping comprising a greater number of heating sub-elements than the second grouping, the peak power routed to each of the heating sub-elements in the second grouping in the concentrated operating mode is greater than the peak power routed to each of the heating sub-elements the first grouping in the regular operating mode.

In a particular case of the cooking element, in the concentrated operating mode, the control unit routes no power to the heating sub-elements not in the second grouping.

In another case of the cooking element, in the concentrated operating mode, the control unit routes power to the heating sub-elements not in the second grouping below the respective peak outputs of such heating sub-elements.

In yet another case of the cooking element, the first grouping comprises all the heating sub-elements of the cooking element.

In yet another case of the cooking element, the peak power routed to each of the heating sub-elements in the second grouping in the concentrated operating mode comprises a respective fraction of a total power supplied to the cooking element divided by the respective peak outputs of the heating sub-elements.

In yet another case of the cooking element, the cooking element has a total power output of 1600 W, and the peak output of at least one of heating sub-elements is 1600 W.

In yet another case of the cooking element, selectively routing majority or entire power to the at least one heating sub-element operates said at least one heating sub-element at the peak power level associated with said at least one heating sub-element.

In yet another case of the cooking element, the heating sub-elements are arranged side-by-side within an area of the cooking element.

In yet another case of the cooking element, the heating sub-elements are arranged concentrically within an area of the cooking element.

In yet another case of the cooking element, the heating sub-elements in the second grouping provide a small heating area than the heating sub-elements in the first grouping.

In another aspect, there is provided a method of selectably concentrating power of a cooking element, the method comprising: receiving a selection of a regular operating mode or a concentrated operating mode; routing power to a first grouping of the heating sub-elements in the cooking element in the regular operating mode; and routing power to a second grouping of the heating sub-elements in the concentrated operating mode, the first grouping comprising a greater number of heating sub-elements than the second grouping, the peak power routed to each of the heating sub-elements in the second grouping in the concentrated operating mode is greater than the peak power routed to each of the heating sub-elements the first grouping in the regular operating mode.

In a particular case of the method, in the concentrated operating mode, no power is routed to the heating sub-elements not in the second grouping.

In another case of the method, in the concentrated operating mode, power is routed to the heating sub-elements not in the second grouping below respective peak outputs of such heating sub-elements.

In yet another case of the method, the peak power routed to each of the heating sub-elements in the second grouping in the concentrated operating mode comprises a respective fraction of a total power supplied to the cooking element divided by a respective peak outputs of the heating sub-elements.

In yet another case of the method, the cooking element has a total power output of 1600 W, and the peak output of at least one of heating sub-elements is 1600 W.

In yet another case of the method, the first grouping comprises all the heating sub-elements of the cooking element.

### BRIEF DESCRIPTION OF THE DRAWINGS

The present invention is described by way of embodiments illustrated in the accompanying drawings, wherein:

FIG. 1 is top view of a cooking element with a selectably concentratable power arrangement in accordance with an embodiment;

FIG. 2 is a cross-sectional view of the cooking element illustrating a control unit;

FIG. 3a is a top view of the cooking element illustrating power output levels of the heating sub-elements in an example;

FIG. 3b is a top view of the cooking element illustrating power output levels of the heating sub-elements in another example;

FIG. 4 is a top view of the cooking element illustrating a concentrated heating zone in an example;

FIG. 5 is a top view of the cooking element illustrating a concentrated heating zone in another example; and

FIG. 6 is a flow chart illustrating a method of selectably concentrating power of a cooking element, in accordance with an embodiment.

### DETAILED DESCRIPTION

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the scope described herein. The terminology and phraseology used herein is for the purpose of describing exemplary embodiments and should not be considered limiting. Thus, the present disclosure is to be accorded the widest scope encompassing numerous alternatives, modifications and equivalents consistent with the principles and features disclosed herein. For purposes of clarity, details relating to technical material that is known in the technical fields related to what is described herein have been briefly described or omitted so as not to unnecessarily obscure the present disclosure.

Various terms used throughout the present description may be read and understood as follows, unless the context indicates otherwise: singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. It is to be noted that, as used in the present description, by the term “substantially” it is meant that the recited characteristic, parameter, or value need not be achieved exactly, but that deviations or variations, including for example, tolerances, measurement error, measurement accuracy limitations and other factors known to those skilled in the art, may occur in amounts that do not preclude the effect the characteristic was intended to provide. The term “on-demand” as used in the present description means whenever required or need based. Further definitions for terms may be set out herein; these may apply to prior and subsequent instances of those terms, as will be understood from a reading of the present description.

Generally, with typical heating elements for cooking appliances, there is a limit of peak power output for a cooking element depending on the size of the element. For example, for electrical resistive coil elements, a larger coil would require more power to heat the longer length of the coil, and would have a lower peak power output than a smaller coil. However, merely providing smaller heating surfaces can have substantial drawbacks as such elements limit the cooking capability when cooking larger meal portions that may require low to medium temperatures over a larger area are to be prepared. Additionally, the reduction in the size of the element also leads to an additional cost of having separate larger and smaller cooking elements.

In some approaches, multiple partial heating elements, in a cooking hob, can be selectable to distribute power over the partial elements in a subarea. In such approaches, to select power, a target power is received, then a maximum number of heating elements are selected, where, at the highest power level, they do not together exceed the target power. However, in such approaches, only the smallest arrangement of heating elements are used to provide a given power level. Thus, such approaches have a substantial limitation in that they do not offer the ability for a larger arrangement that has a smaller power output level because the larger, less power output, arrangement would not be used if a smaller arrangement is possible. Thereby, not providing the user the substantial flexibility offered by being able to select between the arrangements.

In other approaches, cooking surfaces can be provided that include a number of individually controllable heating zones, with heating elements disposed beneath each heating zone. Each heating element having a different output heating power density. For example, one of the heating elements can act as a higher-wattage “ramping” heater to quickly ramp up cooking surface temperature and the other heating element can act as a lower-wattage heater to maintain the temperature. However, such approaches provide two separate heating elements that are not to be operated simultaneously. This substantially increases costs and material over other more flexible approaches, as described in the present embodiments, that provide heating sub-elements that can be used in both high-output power and low-output power operations.

In light of such drawbacks, there is a need for a cooking element that facilitates effective concentration of power for higher temperature applications in a limited input power supply circuit, for example, a 15 AMP, 120V circuit. There is a need for a cooking element and a method that can selectively concentrate higher power over a predetermined area of a cooking surface. In particular, there is a need for a cooking element that can selectively concentrate higher power or higher heat over smaller areas of the cooking surface while still retaining the ability to provide moderate heat across the entire cooking surface, without compromising on the larger size of the heating surface. Further, there is need for a cooking element and a method that ensures sustained heat energy supplied over a predetermined area and solves the limitation of amount energy and total watts. Yet further, there is a need for a method that can effectively provide power concentration in conjunction with any of the existing cooking element designs and materials. Yet further, there is need for cooking element and a method for concentrating power which are economical.

The present embodiments disclose a cooking element with a selectively concentrated power arrangement and a method of selectively concentrating power in the cooking element. In particular, a cooking element and a method that selectively enables higher temperature applications in a limited input power supply circuit without compromising on the size of cooking surface. In operation, a cooking element is provided that comprises two or more heating sub-elements. The two or more heating sub-elements together configured to uniformly heat an entire area of a heating surface of the cooking element at respective power levels, such that the sum of the respective power levels of the two or more heating sub-elements is equivalent to a total output power level of the element in a regular operating mode. In some cases, some heating sub-elements are selectively capable of utilizing the entire input power supply alone or in combination with other heating sub-elements; while cutting off or reducing power supply to the remaining heating sub-elements. This is to provide a concentrated power output equivalent to the total output power level over a predetermined area of the heating surface in a concentrated power mode. Thus, providing an on-demand concentrated heat zone, such as for searing food, with continuous sustainable heat over a predetermined area of the heating surface without modifying input power supply or the size of the heating surface.

For simplicity and clarity of illustration, where considered appropriate, reference numerals may be repeated among the Figures to indicate corresponding or analogous elements. In addition, numerous specific details are set forth in order to provide a thorough understanding of the embodiments described herein.

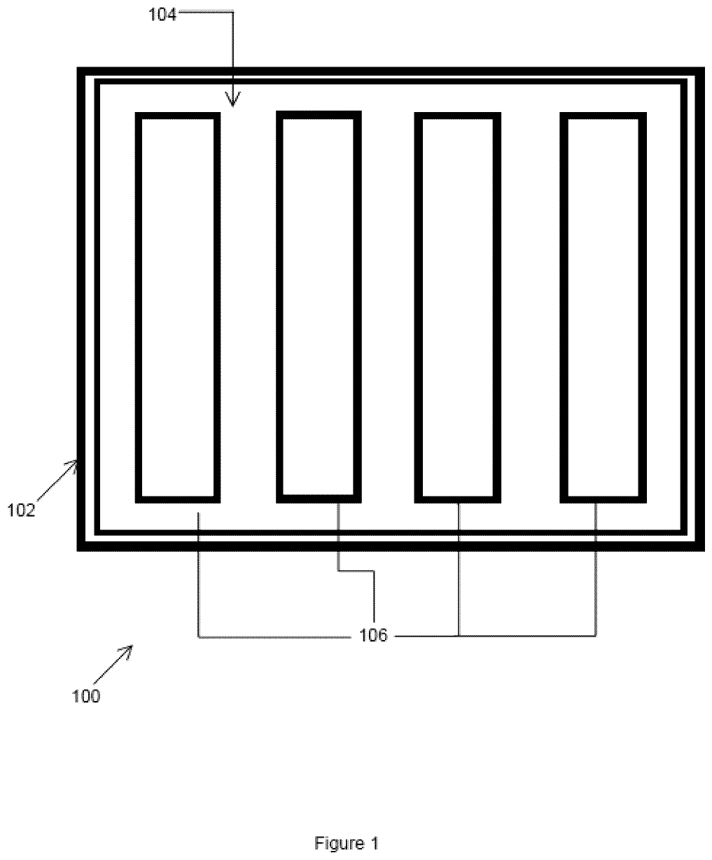

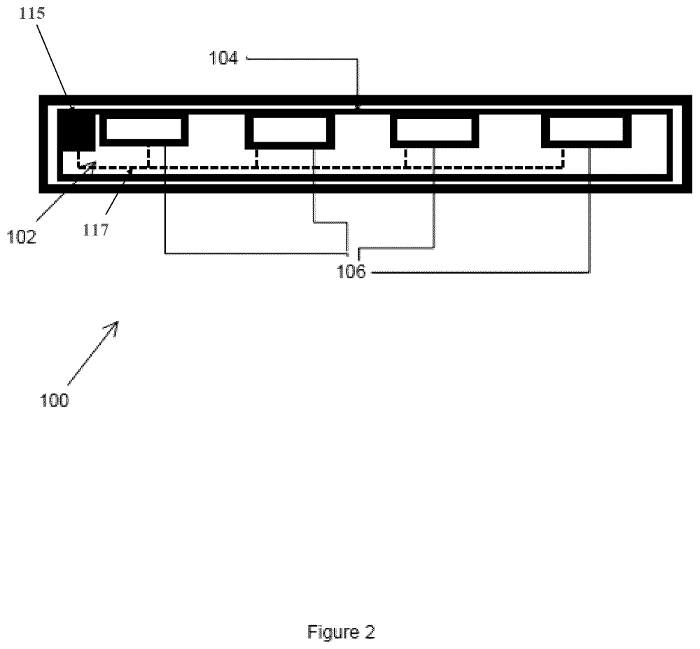

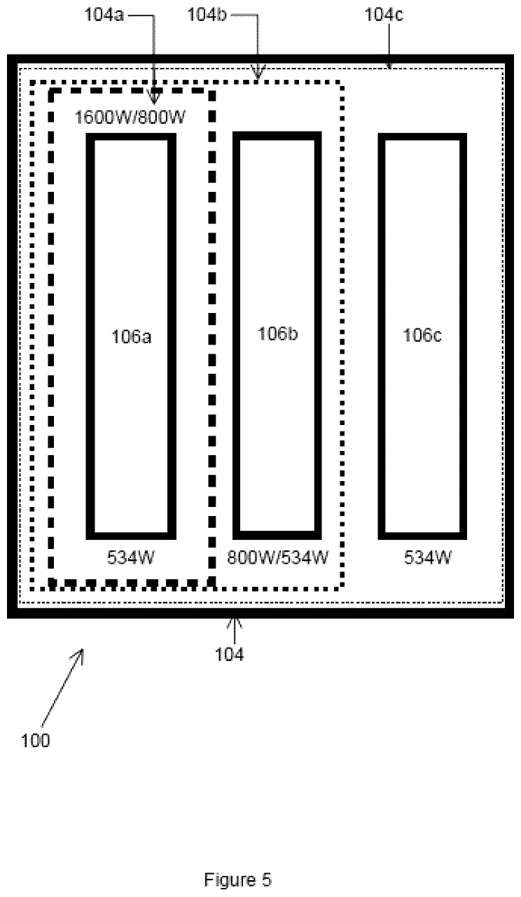

Referring to FIG. 1 and FIG. 2, a cooking element (100) with a selectable concentrated power arrangement, in accordance with an embodiment, is illustrated. The cooking element (100) can be located on the top of a stove, grill, or other cooking appliance. In many cases, the cooking appliance can have an array of cooking elements (100), for example, an arrangement of four elements over a cooktop surface. The cooking element (100) comprises a element chamber (102), a heating surface (104) disposed on top of the element chamber (102), two or more heating sub-elements (106) disposed within the element chamber (102) and in thermal communication with the heating surface (104), and a control unit (115). The control unit (115), conceptually illustrated in FIG. 2, is configured to receive power from an input power supply (not shown), receive inputs from a user via a user interface (not shown), and at least route power to the two or more heating sub-elements (106) via an electrical connection (117). The element chamber (102) and the heating surface (104) may be integrated such as to form a housing for the two or more heating sub-elements (106). While FIGS. 1 and 2 illustrate an arrangement of four heating sub-elements (106), it is understood that any suitable number of heating sub-elements (106) can be used. The heating surface (104) and the two or more heating sub-elements (106) may be integrated, such as to form a single heating assembly securable to the element chamber (102). The single heating assembly comprises two or more heating zones demarcated based on the power level and/or the number of the heating sub-elements (106) as described herein with reference to FIG. 5. The cooking element (100) is configured to operate in at least a regular operating mode, where the power is uniformly distributed amongst each of the two or more heating sub-elements (106) to heat an entire area of the heating surface (104), and a concentrated power mode, where the power is concentrated over a predetermined smaller portion of the heating surface (104).

The shape of the element chamber (102) can have any suitable shape, for example, rectangular, square, circular, oval or any other geometrical shape. In further cases, the element chamber 102 can be omitted and the elements 106 can be incorporated into the cooking element. The element chamber (102) may be made from any of the materials capable of withstanding high temperatures, such as metals. The dimensions of the element chamber (102) may be selected based on the area desired for the heating surface (104) and also the dimensions of the two or more heating sub-elements (106).

The heating surface (104) is disposed on top of the element chamber (102). As shown in FIG. 1 and FIG. 2, the heating surface (104) lies flat on to the element chamber (102); however any suitable arrangement for the heating surface can be used, such as having the sub-elements (106) directly exposed. In this case, the heating surface (104) is a cooking surface, such as, but not limited to, a cooktop or grill. As shown in FIG. 1 and FIG. 2, the heating surface (104) comprises two or more heating zones selectable based on a selection of a grouping of the two or more heating sub-elements (106). In some cases, the heating surface (104) comprises at least a distributed heating zone, where the entire heating surface (104) is heated, and a concentrated heating zone, where at least a predetermined smaller portion of the heating surface (104) is heated with concentrated power.

The two or more heating sub-elements (106) are disposed within the element chamber (102). As shown in FIG. 1 and FIG. 2, each of the two or more heating sub-elements (106) are arranged from side-by-side within the element chamber (102). Generally, the size and shape of each of the heating sub-elements (106) are selected based on the area of heating surface (104) to be covered. In the illustrated case, each of the two or more heating sub-elements (106) have a length that covers the element chamber (102) from front to back and each of the two or more heating sub-elements (106) are evenly spaced with respect to each other within the element chamber (102); however, any suitable sizing and spacing can be used. It is to be understood that any other suitable arrangements of the heating sub-elements can be used; for example, circular sub-elements (106) that are concentrically arranged, rows of sub-elements (106), or the like. The two or more heating sub-elements (106) can comprise, for example, electrical resistive heating sub-elements, inductive heating sub-elements, infrared heating sub-elements, quartz halogen bulb heating sub-elements, or the like.

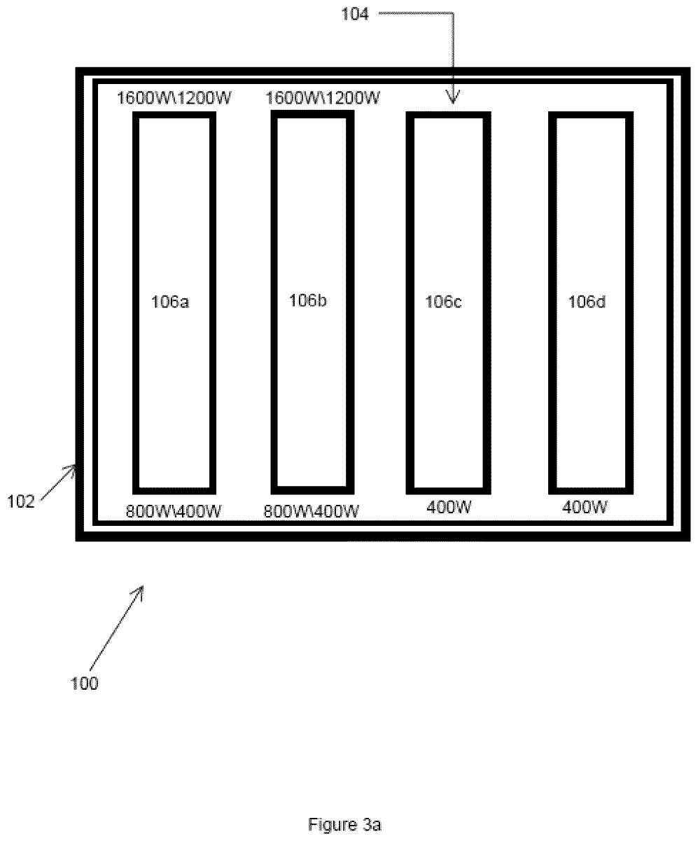

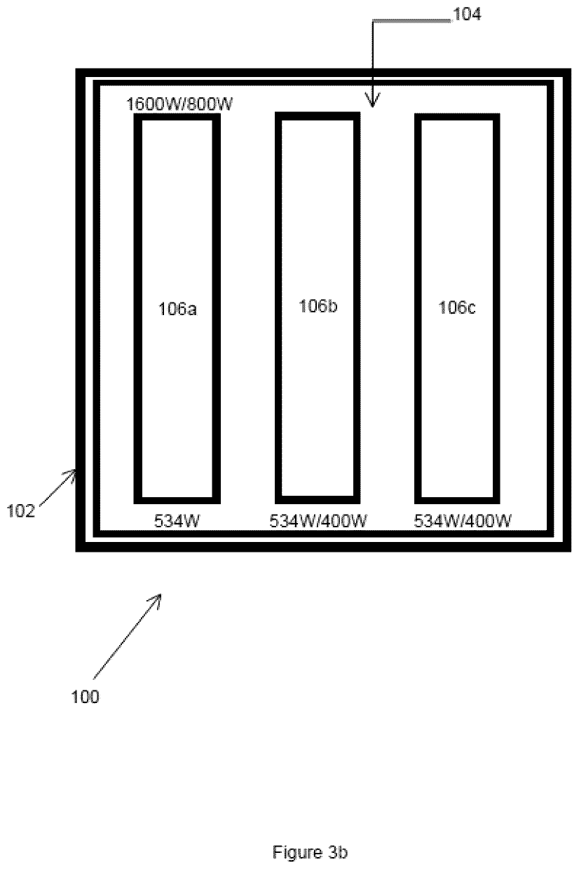

Each of the two or more heating sub-elements (106) have respective output power levels, also referred to as power capacity or peak output. A grouping of one or more of the heating sub-elements (106) is capable of reaching an output power level significantly higher than the output of all, or a larger grouping, of the heating sub-elements (106). In some cases, the grouping of at least one heating sub-element has an output power level equivalent to the total output power of the cooking element (100). Generally, the output power level of the grouping of heating sub-elements (106) is substantially great than (e.g., double) the output power level of the remaining heating sub-elements (106) not in the grouping. In some cases, each of the two or more heating sub-elements (106) are respectively capable of reaching an output power level equivalent to the total output power level one at a time. The output power levels of the two or more heating sub-elements (106) are exemplified with reference to FIGS. 3a and 3b.

The output power levels of the two or more heating sub-elements can be preset or automatically selected by the control unit (115) as per the mode of operation of the cooking element (100); i.e., regular mode or concentrated power mode. The output power levels of the two or more heating sub-elements (106) are selected such that, at any time during operation, the combined power output level of the heating sub-elements (106) selected for operation does not exceed the total output power of the cooking element (100). In an example, assuming that there are four heating sub-elements (106), each of the 4 heating sub-elements individually capable of reaching a maximum power level of 1600 W (which is the output power level of the cooking element (100)). In the example, during regular operating mode, each of the heating sub-elements (106) operate at a maximum power level of 400 W for an even distribution of heat throughout the heating surface (104). In the same example, one of the heating sub-elements may operate at 1600 W while cutting off power to the remaining heating sub-elements (106) in a concentrated power mode. Further, two heating sub-elements (106) may operate at 800 W each while cutting off power to the remaining heating sub-elements (106) in a concentrated power mode.

The two or more heating sub-elements (106) are thermally coupled with the heating surface (104). In operation, each of the two or more heating sub-elements (104) is configured to heat a predetermined area of the heating surface (106) at a preset or selected output power level of the respective two or more heating sub-elements (106). The predetermined area of the heating surface (104) may be substantially equal for each of the two or more heating sub-elements (106) or unequal depending on the size and power level of the respective heating sub-elements (106).

The two or more heating sub-elements (106) are configured to generate heat based on the electrical energy received from an input power supply via the control unit (115). The control unit (115) is coupled with at least the two or more heating sub-elements (106). The control unit (115) is configured to receive power from the input power supply (not shown) and at least supply power to the two or more elements (106.) In an example, the control unit (115) is configured to receive power from at least a 15 AMP 120V power supply. Further, the control unit (115) is configured to selectively distribute a maximum power wattage of 1800 W or less to the two or more heating sub-elements (100) based on the total power level of the cooking element (100) and/or the preset/selected output power level of the two or more heating sub-elements (106). In an example, the control unit (115) is thermostatic control unit. In an example of operation, the control unit (115) is configured to evenly distribute power to each of the two or more heating sub-elements (106) under regular operating mode, such that the entire area of the heating surface (104) is approximately uniformly heated. Further, the control unit (115) is configured to selectively route the entire or higher power to a grouping of at least one of the heating sub-elements (106) to have significantly higher output power level, under a concentrated power mode; whereby at least a predetermined area of the heating surface (104) is heated for higher temperature applications, such as for searing of food. The control unit (115) can be implemented using any suitable approach, such as electrical circuitry, microprocessors, computer processors, or the like. In some cases, the control unit (115) can include an input interface and/or output interface to receive inputs from the user and/or provide information to the user; for example, switches, dials, touchscreens, diode displays, speakers, or the like.

Referring to FIG. 3a, exemplary power output levels of the heating sub-elements (106) are shown. As shown in FIG. 3a, the cooking element (100) has four heating sub-elements (106a, 106b, 106c and 106d). In this example, at least one of the four heating sub-elements (106a) has a significantly higher output power level equivalent to the total output power of the cooking element (100). In particular, the at least one heating sub-element (106a) is selectively capable of utilizing the entire input power supply alone or in combination with other heating sub-element s (106b, 106c and 106d). Assuming that the heating sub-elements (106b, 106c and 106d) have a power level of 400 W each and heating sub-element (106a) can selectively operate anywhere from 400 W to 1600 W, then under regular operating mode, the heating sub-elements (106a, 106b, 106c and 106d) together each operate at a maximum of 400 W, or less, to approximately uniformly heat an entire area of a heating surface (104), such that the sum of the respective power levels of the heating sub-elements is equivalent to a total output power level of the element (100). Further, in a concentrated mode, the heating sub-element (106a) may operate at a maximum of 1600 W alone for concentrated power over a predetermined area while cutting off power supply to heating sub-elements (106b, 106c and 106d). Furthermore, the heating sub-element (106a) may operate at 800 W, and heating sub-elements (106b and 106c) may operate at 400 W each while cutting off supply to the heating sub-element (106d). Yet further, the heating sub-element (106a) may operate at 1200 W, along with any one of the heating sub-elements (106b, 106c and 106d).

In accordance with another example, assuming that the heating sub-elements (106a and 106b) are capable of utilizing the entire input power supply alone or in combination with other heating sub-elements (106c and 106d). Further, assuming that the heating sub-elements (106c and 106d) have a maximum output power level of 400 W each and the heating sub-element (106a and 106b) can selectively operate anywhere from 400 W to 1600 W, then under regular operating mode, the heating sub-elements (106a, 106b, 106c and 106d) operate at a maximum of 400 W each, or less. Also, in a concentrated mode, the heating sub-element 106a may operate at 1600 W alone or heating sub-element 106b may operate alone for concentrated power over a predetermined area while cutting off power supply to other heating sub-elements. Further, the heating sub-element (106a and 106b) may operate at 800 W, while cutting off supply to the heating sub-element (106c and 106d).

Referring to FIG. 3b, exemplary power output levels of the heating sub-elements (106) are shown. As shown in FIG. 3b, the cooking element (100) has three heating sub-elements (106a, 106b, and 106c). In this example, at least one of the three heating sub-elements (106a) has a selectively higher output power level equivalent to the total output power of the cooking element (100). In particular, the at least one heating sub-element (106a) is selectively capable of utilizing the entire input power supply alone or in combination with other heating sub-elements (106b and 106c). Assuming that the heating sub-elements (106b, and 106c) can operate at a maximum power level of 400 W-534 W each, and the heating sub-element (106a) can selectively operate at a maximum of 534 W, 800 W or 1600 W, then under regular operating mode, the heating sub-elements (106a, 106b, and 106c) together operate at a maximum of 534 W each to uniformly heat an entire area of the heating surface (104); such that the sum of the respective power levels of the heating sub-elements is equivalent to a total output power level of the element (100). Also, in a concentrated mode, the heating sub-element (106a) may alone operate at a maximum of 1600 W for concentrated power over a predetermined area while cutting off power supply to heating sub-elements (106b, and 106c). Further, in another concentrated power mode the heating sub-element (106a) may operate at a maximum of 800 W, and heating sub-elements (106b or 106c) may operate at a maximum of 400 W while cutting off supply to the remaining heating sub-element. The concentrated power mode provides an on-demand concentrated heat zone with sustainable heat for high temperature applications, such as, but not limited to searing.

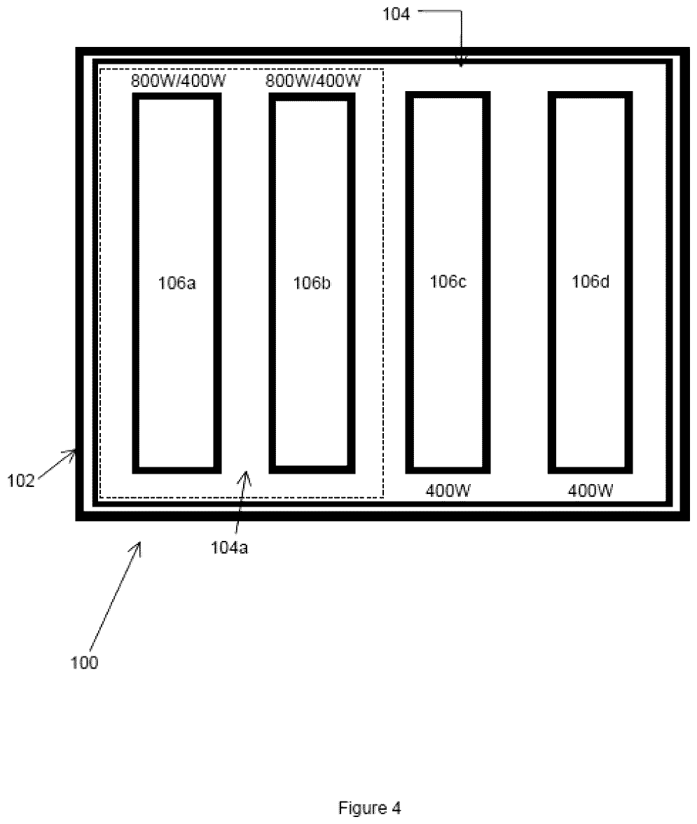

Referring to FIG. 4, shown is a typical example of cooking element (100). As shown, the cooking element (100), has an element chamber (102), a heating surface (104) secured on top of the element chamber (102), and four heating sub-elements (106a, 106b, 106c and 106d) thermally coupled with the heating surface (104). The cooking element (100) is configured to operate in a regular operating mode and a concentrated power mode. The heating surface (104) has an area of approximately 300 square inches. As shown, the heating sub-elements (106a and 106b) have a peak output power level of 800 W each. The heating sub-elements (106c and 106d) have a peak output power level of 400 W each. Each of the heating sub-elements (106a, 106b, 106c and 106d) are configured to receive power from an input power supply (not shown) of 15 AMP, 120 V via a control unit (115). In operation, each of the heating sub-elements (106a, 106b, 106c and 106d) operate at a maximum of 400 W each in regular operating mode, where power is evenly distributed, thus distributing heat or energy evenly across the entire heating surface (104). In concentrated power mode, the two high powered heating sub-elements (106a and 106b) are operated at 800 W each, utilizing the entire input supply, while cutting off power to the heating sub-elements (106c and 106d). Thereby, effectively doubling the output heat from the elements (106a and 106b) and concentrating the same to a smaller area (104a) of the heating surface (104), thus allowing a much higher maximum temperature in that smaller area.

Referring to FIG. 5, a top view of the heating surface (104) illustrating various heating zones is shown. The heating surface (104) and the two or more heating sub-elements (106) are integrated, such as to form a single heating assembly securable to the element chamber (102). As shown in FIG. 5, the heating surface (104) comprises three heating zones, where one is 1600 W concentrated heating zone (104a) spread over a smaller area of the heating surface (104), the other is 800 W concentrated heating zone (104b) spread over a larger are of the heating surface (104), and a third is a 400 W distributed heating zone (104c) spread over the entire area of the heating surface (104). The entire heating surface (104) is heated by three heating sub-elements (106a, 106b and 106d) together. The heating sub-element (106a) has a maximum capacity of 1600 W, heating sub-element (106b) has a maximum capacity of 800 W, and heating sub-element (106c) has a maximum capacity of 534 W. However, it may be understood that each of the heating sub-elements (106a, 106b and 106c) may have maximum capacity of 1600 W, but only one of the heating sub-elements is operable at maximum capacity at a given time. As shown in FIG. 5, the heating zone (104a) is powered by a heating sub-element (106a) with a maximum power output of 1600 W. The heating zone (104b) is powered by two heating sub-elements (106a and 106b) together, operating at a maximum power output of 800 W each, and the heating zone (104c) is powered by all the three heating sub-elements (106a, 106b and 106c), each operating at 534 W. In operation, the heating zones (104a, 104b and 104c) are selected based on the temperature requirements by routing the entire power to the heating sub-elements associated with the heating zone.

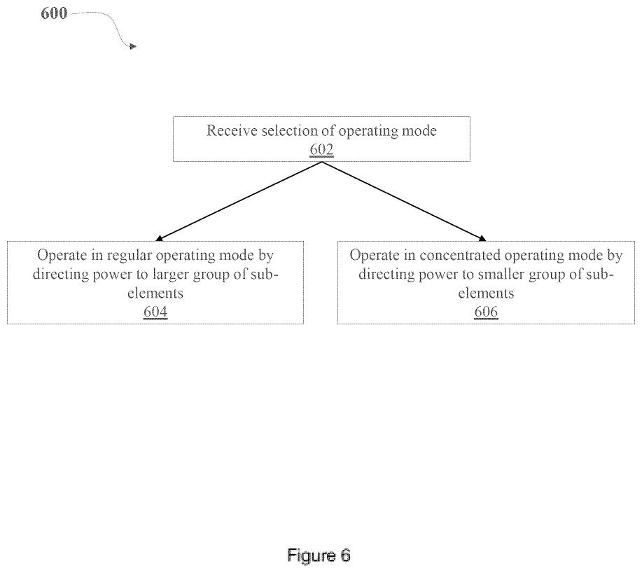

Referring to FIG. 6, a flowchart illustrating a method of concentrating power in a cooking element is shown.

At block 602, a control unit (115) receives a selection of a regular operating mode or a concentrated operating mode; for example, via user interface elements such as switches or touchscreens.

At block 604, the control unit (115) directs power to be evenly distributed to each of the two or more heating sub-elements (106), in the regular operating mode, in order to provide heating over a large area of the heating surface (104). In a particular case, equal power is provided to each of the two or more heating sub-elements (106) such that the sum of the respective peak power levels of the two or more heating sub-elements (106) is equivalent to a total peak output power level of the element (100).

At block 606, the control unit (115) directs higher power to a grouping of the heating sub-elements (106), in the concentrated operating mode. The grouping having at least one, but less than all, of the heating sub-elements (106). This provides a higher power level on a predetermined smaller area of the heating surface. For example, a higher power capacity is selectively routed to the at least one heating sub-element, while cutting off or reducing power supply to the remaining heating sub-elements to provide a much higher power output; thereby concentrating higher heat energy over a smaller area and providing higher temperature. In operation, power is routed to the at least one heating sub-element based on the power level of the heating sub-element and/or the desired temperature.

Advantageously, the cooking element and the method affords high temperature application in a limited input power supply circuit, such as a 15 AMP, 120V circuit by selectively routing higher power to one or more higher power heating sub-elements. Thereby, selectively achieving higher temperatures in smaller areas while still retaining the ability to provide moderate temperatures across the entire heating surface. Further, the cooking element and the method affords on-demand concentrated heat zone with sustainable heat over a predetermined area of the heating surface without modifying input power supply or the size of the heating surface.

While the present embodiments generally describe electrical resistive heating elements; it is understood that the present embodiments can likewise be applied to inductive heating elements, gas heating elements, or the like. In the case of gas heating elements, the power output can instead be gas output to provide a larger area with moderate peak BTU (British thermal unit) capacity and a concentrated area with higher capacity BTU capacity.

While the exemplary embodiments are described and illustrated herein, it will be appreciated that they are merely illustrative. It will be understood by those skilled in the art that various modifications in form and detail may be made therein without departing from the scope of the invention except as it may be described by the claims in the complete specification which will be filed pursuant to the present provisional specification.

1. A cooking element with a selectably concentratable power arrangement, comprising:
two or more heating sub-elements, each of the heating sub-elements having respective peak outputs; and
a control unit, the control unit selectively routing power to a first grouping of the heating sub-elements in a regular operating mode and routing power to a second grouping in a concentrated operating mode, the first grouping comprising a greater number of heating sub-elements than the second grouping, the peak power routed to each of the heating sub-elements in the second grouping in the concentrated operating mode is greater than the peak power routed to each of the heating sub-elements the first grouping in the regular operating mode.

2. The cooking element of claim 1, wherein the first grouping comprises all the heating sub-elements of the cooking element.

3. The cooking element of claim 1, wherein, in the concentrated operating mode, the control unit routes no power to the heating sub-elements not in the second grouping.

4. The cooking element of claim 1, wherein, in the concentrated operating mode, the control unit routes power to the heating sub-elements not in the second grouping below the respective peak outputs of such heating sub-elements.

5. The cooking element of claim 1, wherein the peak power routed to each of the heating sub-elements in the second grouping in the concentrated operating mode comprises a respective fraction of a total power supplied to the cooking element divided by the respective peak outputs of the heating sub-elements.

6. The cooking element of claim 5, wherein the cooking element has a total power output of 1600 W, and the peak output of at least one of heating sub-elements is 1600 W.

7. The cooking element of claim 1, wherein selectively routing majority or entire power to the at least one heating sub-element operates said at least one heating sub-element at the peak power level associated with said at least one heating sub-element.

8. The cooking element of claim 1, wherein the heating sub-elements are arranged side-by-side within an area of the cooking element.

9. The cooking element of claim 1, wherein the heating sub-elements are arranged concentrically within an area of the cooking element.

10. The cooking element of claim 1, wherein the heating sub-elements in the second grouping provide a small heating area than the heating sub-elements in the first grouping.

11. A method of selectably concentrating power of a cooking element, the method comprising:
receiving a selection of a regular operating mode or a concentrated operating mode;
routing power to a first grouping of the heating sub-elements in the cooking element in the regular operating mode; and
routing power to a second grouping of the heating sub-elements in the concentrated operating mode, the first grouping comprising a greater number of heating sub-elements than the second grouping, the peak power routed to each of the heating sub-elements in the second grouping in the concentrated operating mode is greater than the peak power routed to each of the heating sub-elements the first grouping in the regular operating mode.

12. The method of claim 11, wherein the first grouping comprises all the heating sub-elements of the cooking element.

13. The method of claim 11, wherein, in the concentrated operating mode, no power is routed to the heating sub-elements not in the second grouping.

14. The method of claim 11, wherein, in the concentrated operating mode, power is routed to the heating sub-elements not in the second grouping below respective peak outputs of such heating sub-elements.

15. The method of claim 11, wherein the peak power routed to each of the heating sub-elements in the second grouping in the concentrated operating mode comprises a respective fraction of a total power supplied to the cooking element divided by a respective peak outputs of the heating sub-elements.

16. The method of claim 15, wherein the cooking element has a total power output of 1600 W, and the peak output of at least one of heating sub-elements is 1600 W.
